(19) United States
(12) Patent Application Publication
(10) Pub. No.: US 2009/0087520 A1
(43) Pub. Date: Apr. 2, 2009

(54) Advertising inserts for fortune cookies and methods for their dissemination

(76) Inventors: Marcus L. Thuesen, Houston, TX (US); Lejo C. Brana, Houston, TX (US)

Correspondence Address: KEITH B. WILLHELM, ATTORNEY AT LAW, 6266 DEL MONTE, HOUSTON, TX, 77057, US

(21) Appl. No.: 10/757,152

(22) Filed: Jan. 14, 2004

(51) Int. Cl. G09F 23/06

(52) U.S. Cl. 426/87; 426/383

(57) ABSTRACT

Methods for disseminating advertising messages to consumers of fortune cookies are provided for. The methods comprise providing novel inserts constructed in accordance with the subject invention. The novel inserts have imprinted thereon an advertising message which may be viewed by a consumer. Fortune cookies are produced with novel inserts carried therein, and the fortune cookies are distributed to consumer outlets, such as food service establishments, and thence to consumers associated with the consumer outlets.

The novel fortune cookie inserts comprise various embodiments, including inserts comprising a plurality of superimposed, imprintable substrate sheets; inserts comprising a plurality of imprintable substrate sheets, wherein the substrate sheets are affixed to each other; inserts comprising an imprintable substrate sheet having a fold therein, and preferably a horizontally or vertically oriented fold therein; inserts wherein the advertising message imprinted on the insert includes a manufacturer coupon redeemable by a consumer of the fortune cookie having imprinted thereon machine readable indicia to facilitate automated processing of the coupon. Preferably the machine readable indicia are a UPC bar code utilizing the UCC/EAN-128 Article Numbering System or another bar code.

Methods for packaging and distributing fortune cookies for dissemination to a target consumer group also are provided for. The methods comprise providing fortune cookies having an advertising insert which has an advertising message for a target consumer group. The fortune cookies are packed in a shipping carton having a machine readable indicator uniquely associated with the advertising message. The indicator is read and the carton is then shipped to consumer outlets associated with the target consumer group.

### FIELD OF THE INVENTION

The present invention relates to fortune cookies having advertising messages and to methods for disseminating advertising messages, and more particularly, to fortune cookies comprising improved advertising inserts and to methods for disseminating advertising messages to consumers of fortune cookies.

### BACKGROUND OF THE INVENTION

Fortune cookies are a traditional and nearly universal part of the dining experience in Chinese restaurants in the United States. They typically are presented at the end of a meal with the check. Diners eagerly break open the crispy cookies to find a small slip of paper with a fortune or message.

The recipe for fortune cookies is relatively simple. The dough is made from egg whites, sugar, butter, and flour flavored with vanilla. A thin circular sheet of dough is then baked. Before the baked dough cools and while it is still pliable, a message slip is placed on the sheet and the dough is folded and crimped into the traditional puffed arch shape.

The history of fortune cookies can be traced to the Yuan Dynasty of fourteenth century China. China was then occupied by the Mongols. Chu Yuan Chang, the leader of the “Red Turbans” Han resistance movement, was attempting to capture the city of Ch'u-chou, a highly fortified and strategically important city. While the idea is sometimes attributed to Chu's chief military advisor Liu Po-wen, a plan was devised to rally the inhabitants of the city by using “moon” cakes, a popular Chinese pastry made from lotus nut paste. Disguised as a Taoist priest, Chu entered the city and began to spread a rumor among the city's Han population that a plague was ravaging the land. The Hans were given moon cakes and told that the only way the plague could be avoided was by eating them at the first stroke of the third watch during the Mid-Autumn Festival. The moon cakes had a tiny slip of paper with a secret message printed on them: “Revolt on the fifteenth of the eighth moon. Our army will join you at the fifth watch.” The uprising was successful and led to the establishment of the Ming dynasty in 1368. Thereafter, it became common for the Chinese to exchange moon cakes containing messages of good will during New Year and other holidays.

The modern fortune cookie, however, was invented in the United States. The wave of Chinese immigrants that came to America to build the transcontinental railroads brought with them the tradition of moon cakes. The traditional ingredients were not readily available, however, and so the recipe was changed slightly. Although there is some disagreement as to the exact origin, it is widely believed that the first incarnation of the modern fortune cookie was served by San Francisco restaurateur Makota Hagiwara in 1909 at his Japanese Tea Garden in Golden Gate Park.

The first cookies were baked and formed by hand. The first automated machine for forming fortune cookies was invented by Edward Louie, a Canton-born immigrant living in San Francisco. His machine is the subject of U.S. Pat. No. 3,950,123. Fully automated machines for baking and forming fortune cookies are disclosed in U.S. Pat. No. 4,339,993 to Y. Lee, U.S. Pat. No. 4,426,186 to Y. Lee, and U.S. Pat. No. 4,431,396 to Y. Lee and are commercially available from Sci Technology Inc., Westborough, Mass., U.S.A. Such machines typically incorporate one or more vacuum fingers that place individual message slips onto a baked cookie dough or “blank”. Alternatively, a roll of preprinted message slips are fed into a cutter which cuts individual slips which then are allowed to fall onto a cookie blank.

Early fortune cookie message slips carried Bible passages, Confusion epigrams, truisms, famous quotes, and whimsical predictions. Lucky lottery numbers later were printed on the back of the slip. Eventually, however, the potential for delivering advertising and other messages was recognized. Police in Hong Kong have used them to deliver anti-drug messages. Director Billy Wilder promoted his 1966 movie, The Fortune Cookie, by distributing 15,000 cookies to exhibitors, journalists and restaurateurs with the message, “There's a marvelous picture in your future!” More recently, the back side of message slips have carried branding messages.

The potential for effectively delivering advertising messages through fortune cookies is enormous. Many forms of direct advertising are never viewed by their intended audience. For example, direct mail advertising typically generates a 2% overall response rate, but more than______% of direct mail advertising delivered is not viewed by the recipients. Thus, direct mail advertising presents a very inefficient and wasteful form of advertising. Internet advertisements typically have a “view” rate of from 1 to 15%, most commonly on the order of 2%, meaning that the substantial majority of e-mail advertisements are never viewed by their recipients. Message slips in fortune cookies, however, are almost universally viewed, thus, ensuring that advertising messages contained in fortune cookies will be effectively delivered to consumers.

Moreover, the distribution costs for delivering direct mail advertising and other forms of direct advertising are substantial. Distributing advertising messages through fortune cookies is in a sense nearly cost free. That is, other than the cost of printing or otherwise preparing the advertising message itself, there is little incremental cost in disseminating advertising messages through fortune cookies over and above the cost of producing and distributing the cookies themselves.

Unfortunately, the effectiveness of using fortune cookies to disseminate advertising is significantly limited by the size of fortune cookies. Traditionally sized fortune cookies are made from a circular blank that typically is approximately 3 inches in diameter, and conventional machinery for producing fortune cookies are designed to accommodate blanks of that size. The relatively small size of traditional fortune cookies in turns limits the size of the message slip that may be carried therein.

Typically, the message slips are approximately 0.5 to 0.625″ in length and up to approximately 2.75″ wide. Such slips have less than approximately 1.72 square inches of space available for imprinting an advertising message, one face of the slip being reserved for the fortune message. That does not provide space for delivering much more than a branding type message, but larger slips will tend to crimp unacceptably in traditionally sized fortune cookies. Traditionally sized message slips, therefore, have proven unsuitable for delivering more extensive and sophisticated advertising messages.

In particular, many products, such as food and consumer household products, are promoted extensively using manufacturer coupons. Such coupons typically offer a discount on specifically identified products and are distributed to consumers through various media such as newspapers and direct mailings. Consumers may redeem the coupons with merchants selling the product. The merchants in turn are reimbursed by the manufacturer or distributor of the product. The vast majority of manufacturer coupons are redeemed by merchants through a clearing house such as NCH Marketing Services, Deerfield, Ill. The automated processing of such manufacturer coupons essentially requires that they incorporate machine readable indicia, such as UPC bar codes utilizing the UCC/EAN-128 Article Numbering System. Information on standards for manufacturer coupons is publicly available, for example, through Uniform Code Council, Inc., Lawrenceville, N.J., and through Grocery Manufacturers of America, Inc., Washington, D.C. The message slips in traditionally sized fortune cookies, however, as a practical matter are too small to accommodate a bar code and even minimal product identification as is required to produce a consumer redeemable, manufacturer coupon.

Oversized fortune cookies have been sold commercially. For example, 17-inch fortune cookies with customized messages have been offered for sale. While oversized cookies do accommodate much larger message slips, they are much more expensive than traditionally sized fortune cookies and may provide more cookie than most consumers care to eat. Such oversized cookies and message slips also appear to be hand made and poorly suited to conventional automated machinery used to produce fortune cookies. More importantly, however, those factors tend to discourage mass distribution of fortune cookies and, therefore, limit the reach of an advertising campaign.

An object of this invention, therefore, is to provide improved methods for disseminating advertising messages to consumers of fortune cookies and improved advertising inserts suitable for use in fortune cookies.

It also is an object to provide advertising inserts capable of delivering more extensive and sophisticated advertising messages, such as redeemable manufacturer coupons, especially such inserts that may be used to advantage in traditionally sized fortune cookies.

Another object of this invention is to provide such advertising inserts having increased imprintable surface area, and especially such inserts that may be used to advantage in traditionally sized fortune cookies.

Yet another object is to provide such improved advertising inserts that may be inserted by conventional machinery and processes used in mass producing fortune cookies with little or no modification.

It is a further object of this invention to provide such methods and inserts wherein all of the above-mentioned advantages are realized.

Those and other objects and advantages of the invention will be apparent to those skilled in the art upon reading the following detailed description and upon reference to the drawings.

### SUMMARY OF THE INVENTION

The subject invention provides for methods for disseminating advertising messages to consumers of fortune cookies. The methods comprise providing novel inserts constructed in accordance with the subject invention and selected from the group consisting of all or any combination of said novel inserts. The novel inserts have imprinted thereon an advertising message which may be viewed by a consumer. Fortune cookies are produced with novel inserts carried therein, and the fortune cookies are distributed to consumer outlets, such as food service establishments, and thence to consumers associated with the consumer outlets.

The novel fortune cookie inserts comprise various embodiments, including inserts comprising a plurality of superimposed, imprintable substrate sheets; inserts comprising a plurality of imprintable substrate sheets, wherein the substrate sheets are affixed to each other; inserts comprising an imprintable substrate sheet having a fold therein, and preferably a horizontally or vertically oriented fold therein; inserts wherein the advertising message imprinted on the insert includes a manufacturer coupon redeemable by a consumer of the fortune cookie having imprinted thereon machine readable indicia to facilitate automated processing of the coupon. Preferably the machine readable indicia are a UPC bar code utilizing the UCC/EAN-128 Article Numbering System or another bar code.

It will be appreciated that the novel fortune cookie inserts, while still requiring substantially the same space to accommodate them within a fortune cookie, have significantly more area available for imprinting an advertising message. Moreover, by increasing the imprintable area of the insert, more extensive and sophisticated advertising messages may be provided even in traditionally sized fortune cookies. Traditionally sized message slips are poorly suited to much more than very simple branding messages, such as an advertisers name, slogan, or logo. As a practical matter it is impossible to provide a redeemable manufacturer coupon via traditional message slips because of size constraints.

The novel inserts, however, by providing significantly greater imprintable areas, may incorporate much more sophisticated advertising messages. In particular, they have sufficient imprintable surface area to accommodate a manufacturer coupon, including the requisite product information and machine readable bar code used in systems that manage accounting between coupon issuers and merchants. It also will be appreciated that the cost of producing the inserts is minimal compared to the value of the advertising and that the advertising messages may be effectively disseminated for little incremental cost over the normal costs of producing and distributing fortune cookies other than the cost of producing the inserts themselves.

The subject invention also provides for fortune cookies comprising the novel inserts, including traditionally sized fortune cookies where the insert comprises in excess of about 3.5 square inches, and preferably in excess of about 7.0 square inches.

Finally, the subject invention provides for methods for packaging and distributing fortune cookies for dissemination to a target consumer group. The methods comprise providing fortune cookies having an advertising insert which has an advertising message for a target consumer group. The fortune cookies are packed in a shipping carton having a machine readable indicator uniquely associated with the advertising message. The indicator is read and the carton is then shipped to consumer outlets associated with the target consumer group.

### BRIEF DESCRIPTION OF THE DRAWINGS

FIG. 1 is a top plan view of a first preferred embodiment 10 of the advertising inserts of the subject invention, which insert 10 comprises three superimposed imprintable substrate sheets;

FIG. 2 is a cross-sectional view of the novel advertising insert 10 shown in FIG. 1 taken along line 2-2 thereof showing the construction of insert 10;

FIG. 3 is a cross-sectional view similar to the view of FIG. 2 of another advertising insert 110 which is similar to advertising insert 10 shown in FIG. 1, except that it comprises two superimposed sheets;

FIG. 4 is a top plan view of a web 12 from which the novel insert 10 may be fabricated;

FIG. 5 is a schematic view of a system 20 for forming and placing the novel insert in a fortune cookie as the cookie is formed;

FIG. 6 is a top plan view of a second preferred embodiment 30 of the advertising inserts of the subject invention, which insert 30 comprises three laminated imprintable substrate sheets;

FIG. 7 is a cross-sectional view of the novel advertising insert 30 shown in FIG. 6 taken along line 7-7 thereof showing the construction of insert 30;

FIG. 8 is a cross-sectional view similar to the view of FIG. 7 of another advertising insert 130 which is similar to advertising insert 30 shown in FIG. 6, except that it comprises two laminated sheets;

FIG. 9 is a top plan view of a web 32 from which the novel insert 30 may be fabricated;

FIG. 10 is a cross-sectional view of the web 32 shown in FIG. 9 taken along line 10-10 thereof;

FIG. 11 is schematic view of a system 40 for forming and placing the novel insert in a fortune cookie as the cookie is formed;

FIG. 12 is a top plan view of a third preferred embodiment 50 of the advertising inserts of the subject invention, which insert 50 comprises an imprintable substrate sheet having a single horizontal fold therein;

FIG. 13 is a cross-sectional view of the novel advertising insert 50 shown in FIG. 12 taken along line 13-13 thereof;

FIG. 14 is a cross-sectional view similar to the view of FIG. 13 of another advertising insert 150 which is similar to advertising insert 50 shown in FIG. 12, except that it comprises two horizontal folds;

FIG. 15 is a top plan view of a web 52 from which the novel insert 50 may be fabricated;

FIG. 16 is a schematic view of a system 60 for forming and placing the novel insert 50 in a fortune cookie as the cookie is formed;

FIG. 17 is a top plan view of a fourth preferred embodiment 70 of the advertising inserts of the subject invention, which insert 70 comprises an imprintable substrate sheet having a single vertical fold therein;

FIG. 18 is a cross-sectional view of the novel advertising insert 70 shown in FIG. 17 taken along line 18-18 thereof;

FIG. 19 is a cross-sectional view similar to the view of FIG. 18 of another advertising insert 170 which is similar to advertising insert 70 shown in FIG. 17, except that it comprises two vertical folds;

FIG. 20 is a top plan view of a web 72 from which the novel insert 70 may be fabricated;

FIG. 21 is a schematic view of a system 80 for forming and placing the novel insert 70 in a fortune cookie as the cookie is formed;

FIG. 22 is a top plan view of a fifth preferred embodiment 90 of the advertising inserts of the subject invention, which insert 90 comprises a horizontal and a vertical fold and is shown in its unfolded state;

FIG. 23 is a cross-sectional view similar to the view shown in FIG. 7 of another advertising insert 230 which is similar to advertising insert 30, except that the sheets thereof are affixed at only one end of the sheets;

FIG. 24 is a cross-sectional view similar to the view of FIG. 13 of another advertising insert 250 which is similar to advertising insert 50 shown in FIG. 12, except that it comprises two horizontal folds;

FIG. 25 is a cross-sectional view similar to the view of FIG. 18 of another advertising insert 270 which is similar to advertising insert 70 shown in FIG. 17, except that it comprises two vertical folds; and

FIG. 26 is a cross-sectional view similar to the view of FIG. 13 of another advertising insert 190 which is similar to advertising insert 110 except that it has a horizontal fold therein.

### DESCRIPTION OF ILLUSTRATIVE EMBODIMENTS

The subject invention is directed to improved advertising inserts having substantially greater area on which may be imprinted advertising messages and to fortune cookies incorporating such improved advertising inserts. The advertising inserts are composed of an imprintable substrate and may be composed of one or more sheets of such substrate having a total imprintable surface area substantially greater than the surface area of message slips incorporated into traditionally sized fortune cookies.

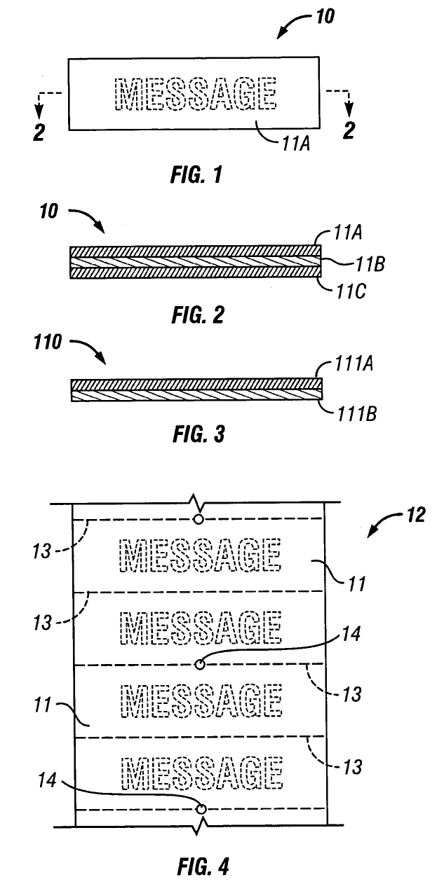

In accordance with a first preferred embodiment, the novel advertising inserts comprise a plurality of superimposed, imprintable substrate sheets. For example, as will be appreciated from FIGS. 1 and 2, insert 10 comprises three superimposed sheets 11a, 11b, and 11c. The novel inserts, however, also may comprise two, four, or more than four superimposed sheets. For example, insert 110 shown in FIG. 3 comprises two sheets 111a and 111b. The precise number of sheets is a matter of choice, although the limit on the number of sheets that may be accommodated in a cookie of a given size will vary depending on the number of factors such as the thickness of the sheets and the stiffness and other physical properties of the substrate. Generally it may be preferable to use thinner sheets as the number of sheets in the insert increases.

The size and folding pattern for the vast majority of fortune cookies is more or less standardized. Moreover, the length and width of message slips used in such traditionally sized fortune cookies appears to be maximized. Accordingly, the length and width of the sheets 11a, 11b, and 11c preferably approximate the length and width of message slips used in traditional fortune cookies so that the novel insert 10 may be used without significant modification of the traditional size and folding pattern of fortune cookies. Such cookies are made from circular dough blanks that typically are approximately 3 inches in diameter. Traditional message slips incorporated into cookies made from blanks of those sizes are typically approximately 0.5 to 0.625″ in length and up to approximately 2.75″ wide. Generally, it will be desirable to maximize the length and width of the sheets 11a, 11b, and 11c, and such values are believed to approximate the dimensional limits imposed by the traditional folding pattern used to produce the distinctive puffed arch shape. In the event that the size of the cookie is increased or decreased, or the folding pattern of the cookie dough is changed, however, the dimensional limits will vary accordingly.

It will be appreciated that by incorporating a plurality of superimposed sheets, the area available for imprinting advertising messages may be increased significantly, yet the space occupied by the insert within a cookie may be substantially the same. For example, if two sheets are used, one side of one sheet may be used to imprint a traditional “fortune” message. Three faces are available for imprinting advertising messages, thereby increasing the amount of advertising space over a traditional message slip by 200%. Similarly, if three sheets are used there will be an increase of 400%. If desired, the fortune message need not be provided, further increasing the space available for advertising messages. The precise number will vary, but it will be appreciated that a number of sheets may be incorporated into the insert without significantly increasing the area required to accommodate the insert.

The sheets 11a, 11b, and 11c may be composed of any of a wide variety of imprintable substrates conventionally used in printed advertising materials. Bond, book, and other types of paper based stock are preferred as they are relatively inexpensive, is suitable for use in food products, may be handled relatively easily by automated equipment, and provide an excellent substrate for conventional printing processes. Machine glazed paper is especially preferred as it will provide improved print quality. Other imprintable films and laminates, such as HDPE films, metallic films, synthetic or natural nonwoven fibrous substrates, are commercially available and may be used, however, as will be appreciated by those of ordinary skill in the art. Such films must enable the imprinting of an advertising message. They also should have tear, tensile, stiffness, memory, and other physical characteristics that render them suitable for use in automated printing and cookie manufacturing equipment. Since fortune cookies are intended for consumption, the substrate must be suitable for use in food products, and most preferably is approved by the U.S. Food and Drug Administration for such use. The sheets used in a single insert also may be made from the same substrate or different substrates.

The advertising message may be imprinted by any of a number of conventional printing processes well know to workers in the art. It will be further appreciated, that in the context of the subject invention, imprinting will be understood not only to include such printing processes, but also impressing, watermarking, bonding, fusing, embossing, burning, stenciling and other processes by which indicia may be imparted to the substrate to communicate the desired advertising message that are suitable for use in association with food products. The precise method of imprinting will be coordinated with the choice of substrate, and vice versa. Printing the advertising message, however, is preferred for cost reasons and because it allows great flexibility in presenting the advertising message. Soy based inks are preferably used as they are suitable for use in association with food products, as are other inks approved by the U.S. Food and Drug Administration for such use.

The advertising message, of course, will be determined by the advertiser. It will be appreciated, however, that when the message includes a manufacturer coupon redeemable by a consumer, it will be advisable to select substrates and imprinting methods that provide relatively high quality printing. That will improve machine readability of the bar code that as a practical matter must be associated with a manufacturer coupon.

Fortune cookies with the novel advertising insert 10 may be produced by making relatively minor modifications to conventional processes and machinery. For example, one type of conventional automated cookie baking and forming machine utilizes a continuous web or roll of preprinted message slips. Typically, the machine includes means for registering the web to ensure that the preprinted messages are cut accurately. For example, the web may have index holes such that it may be fed through an index roller to a cutter. Alternately, the web may be provided with printed indexing bars such that the web may be fed through an optical reader that registers the action of a cutter, and such systems generally provide improved speed and reliability. The cutter, at predetermined intervals, cuts off an individual message slip which is allowed to fall onto the baked cookie blank. The blank is then folded and crimped and allowed to cool.

For example, as shown in FIG. 4, the novel advertising insert 10 may be fabricated from a continuous web 12 that will provide a plurality of sheets 11 defined by cut lines 13, each having a message imprinted thereon. Preferably, the web 12 is provided with index holes 14 to facilitate feeding of the web 12 and accurate registration of the web 12 for subsequent operations as discussed below. Alternately, however, the web may be provided with printed index bars capable of being read by an optical reader the output of which is used to register the web, and such systems are known and used by workers in the art for such purposes.

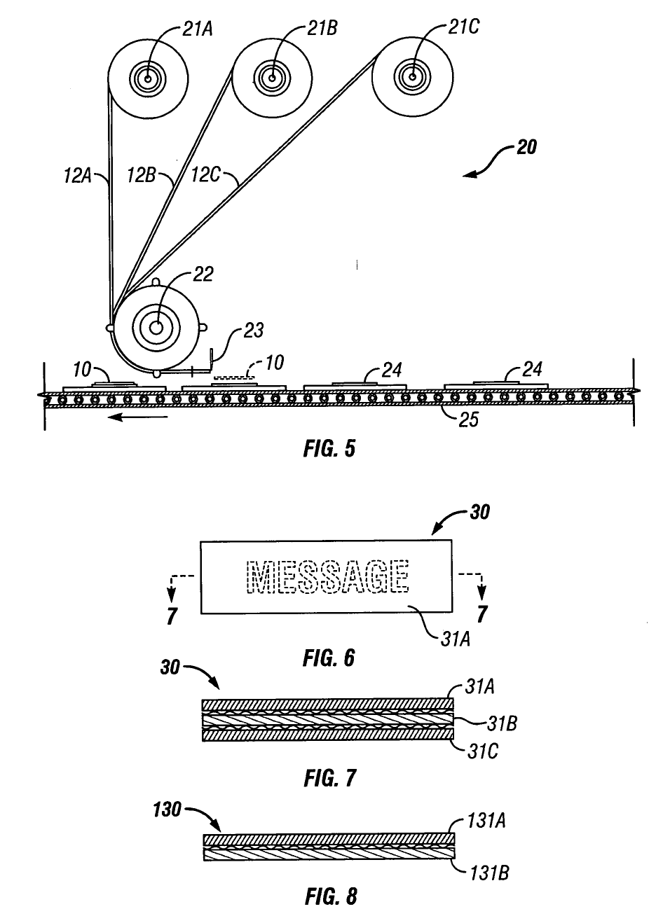

A preferred system 20 for forming and placing the insert 10 in a cookie as it is formed is shown schematically FIG. 5. As shown therein, web 12a is carried on a roll 21a. Similarly webs 12b and 12c are carried on rolls 21b and 21c. All three webs 12a, 12b, and 12c are fed over an index roller 22 to a cutting station where a cutting knife 23 cuts the superimposed webs 12a, 12b, and 12c along the cut lines 13. The insert 10 formed thereby then is allowed to fall onto a cookie blank 24 carried on a conveyor surface 25. While system 20 is preferred because it may be incorporated relatively easily into conventional automated fortune cookie baking apparatus, other systems may be used and will be obvious to those working in the art.

Alternately, all three sheets 11 of insert 10 may be formed from a single web similar to web 12 which is cut three times for each cookie blank. The web would be preprinted accordingly. It will be appreciated that systems for producing such inserts may not require multiple web rolls. Other factors being equal, however, such systems would have lower production rates because each cookie blank must remain in place under the cutting station much longer and the web roll would have to be changed more frequently.

In accordance with a second preferred embodiment, the novel advertising inserts comprise a plurality of imprintable substrate sheets, wherein the substrate sheets are affixed to each other. For example, as will be appreciated from FIGS. 6 and 7, insert 30 comprises three sheets 31a, 31b, and 31c. The novel inserts, however, also may comprise two, four, or more than four sheets. For example, insert 130 shown in FIG. 8 comprises two sheets 131a and 131b. The precise number of sheets is a matter of choice, although the limit on the number of sheets that may be accommodated in a cookie of a given size will vary depending on the number of factors such as the thickness of the sheets. Generally it may be preferable to use thinner sheets as the number of sheets in the insert increases.

Sheets 31a, 31b, and 31c are releasably laminated together preferably by a releasable adhesive. Suitable adhesives are well known to workers in the art, such as a low tack, peelable adhesive. As with the other materials used in the insert 30, the adhesive must be suitable for use in association with food products such as those adhesives approved by the U.S. Food and Drug Administration for such use. Other methods of laminating the sheets are known, however, and may be used provided those methods and materials also suitably bind the sheets and may be used with food products.

The length and width of the sheets 31a, 31b, and 31c, as discussed above in reference to the first preferred embodiment 10, preferably approximate the length and width of message slips used in traditional fortune cookies, but the dimensions may vary as appropriate. Likewise, the sheets 31a, 31b, and 31c may be composed from the same materials and imprinted as discussed above in reference to first preferred embodiment 10.

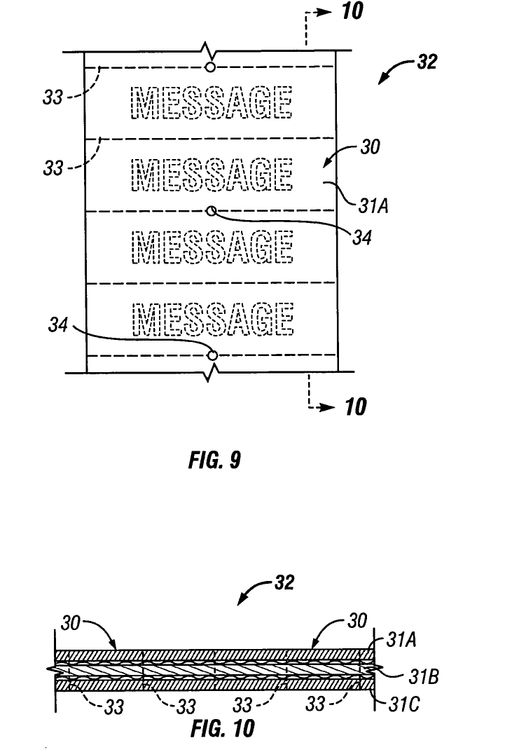

Fortune cookies with the novel advertising insert 30 also may be produced by making relatively minor modifications to conventional processes and machinery. For example, as shown in FIGS. 9 and 10, the novel advertising insert 30 may be fabricated from a continuous laminated web 32 that will provide a plurality of inserts 30 defined by cut lines 33, each sheet 31 thereof having a message imprinted thereon. Preferably, the web 32 is provided with index holes 34 to facilitate feeding and registration of the web Alternately, however, the web may be provided with printed index bars and registered with an optical reader system.

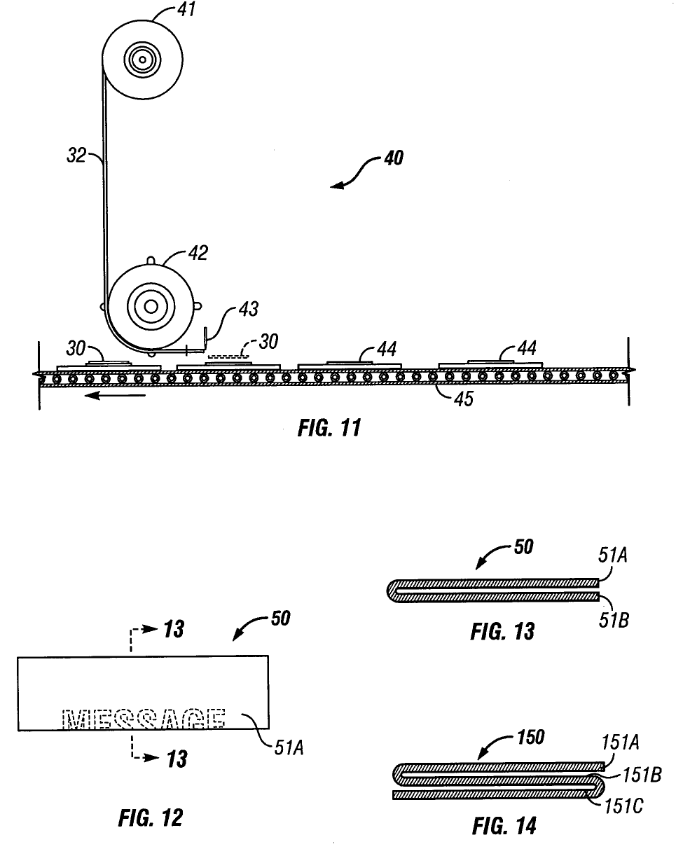

A preferred system 40 for forming and placing the insert 30 in a cookie as it is formed is shown schematically FIG. 11. As shown therein, a preformed laminated web 32 is carried on a roll 41 and fed over an index roller 42 to a cutting station where a cutting knife 43 cuts the laminated web 32 along the cut lines 33. The insert 30 formed thereby then is allowed to fall onto a cookie blank 44 carried on a conveyor surface 45. While system 40 is preferred because it may be incorporated relatively easily into conventional automated fortune cookie baking apparatus, other systems may be used and will be obvious to those working in the art.

Suitable methods and apparatus for producing the laminated web 32 are also known to workers in the art. Alternately, the laminated web 32 may be formed immediately prior to cutting of the inserts. Such a system may include multiple web rolls similar to the system 20 shown in FIG. 5 and may also include suitably configured rollers for applying adhesive and compressing the webs together after adhesive has been applied.

It will be appreciated that the sheets 31 in insert 30 are affixed to each other by a substantially continuous layer of adhesive extending across the entire opposing faces thereof. It is not necessary, however, or even desirable to do so. The adhesive may be applied discontinuously, e.g., in spots or lines. Also, while insert 30 has a laminated structure, i.e., the sheets 31 are affixed together substantially across their entire extent, this embodiment of the subject invention encompasses other structures wherein only a portion of the sheets may be affixed to each other. For example, the substantial portion of the insert may be laminated together, but areas near the edges of the sheets may be left free of adhesive to facilitate separation of the sheets by a consumer. Also, the sheets may be affixed together at only one end thereof. For example, insert 230 shown in FIG. 23, comprises three sheets 231a, 231b, and 231c which are affixed at only one end thereof, the other ends of the sheets being free of adhesives or binders. This forms a “booklet” insert that allows the individual sheets to be viewed and separated more easily by a consumer. Of course, in the event that the sheets are not intended to be separated by a consumer, such a booklet insert may be formed by affixing the ends of the sheets together with a non-releasable adhesive.

Other embodiments of the subject invention have inserts comprising an imprintable substrate sheet have a fold therein. For example, in accordance with a third preferred embodiment, the novel advertising inserts comprise an imprintable substrate sheet having a horizontal fold therein such as insert 50 shown in FIGS. 12 and 13. As shown therein, insert 50 comprises an imprintable substrate sheet 51 having a single fold thereby forming layers 51a and 51b.

The length and width of the formed insert 50, as discussed above in reference to the first and second preferred embodiments 10 and 30, preferably approximate the length and width of message slips used in traditional fortune cookies, but the dimensions may vary as appropriate. Likewise, the substrate sheet 51 may be composed from the same materials and imprinted as discussed above in reference to the other preferred embodiments.

It will be appreciated that by incorporating a horizontal fold, the size of the sheet and the area available for imprinting an advertising message will be increased substantially. For example, if a single horizontal fold is used, the sheet may be made twice as large, but the formed insert will still have the height and width of a traditional message insert. Likewise, with two horizontal folds the sheet may be made three or four times as large, depending on the folding pattern. The space available for imprinting a message will be likewise increased. More importantly, however, the height of the sheet may be increased, and heretofore, the height of traditional message inserts has been severely constrained.

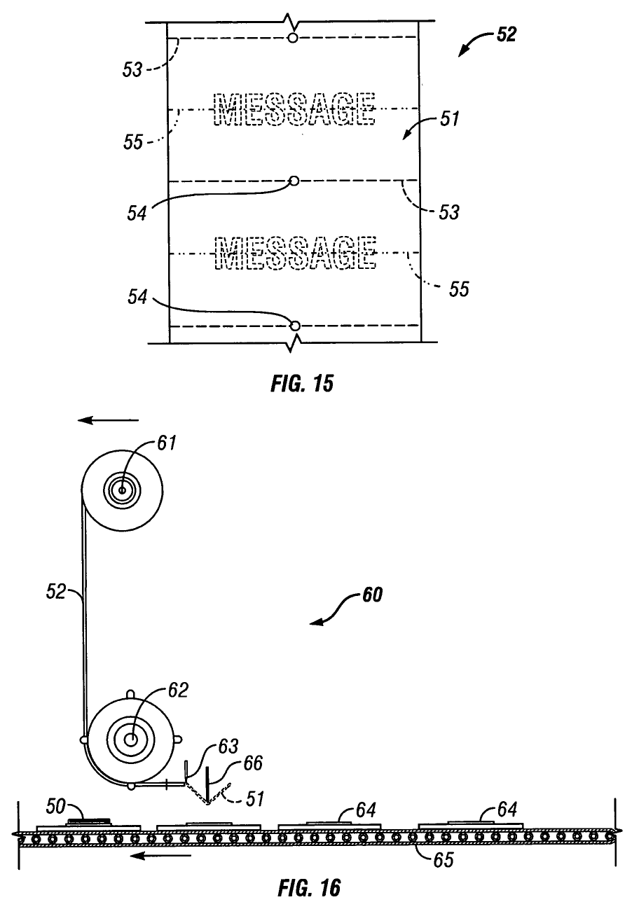

Fortune cookies with the novel advertising insert 50 may be produced by making relatively minor modifications to conventional processes and machinery. For example, as shown in FIG. 15, the novel advertising insert 50 may be fabricated from a continuous web 52 that will provide a plurality of sheets 51 defined by cut lines 53, each having a message imprinted thereon. Preferably, the web 52 is provided with index holes 54 to facilitate feeding and registration of the web 52. Alternately, however, the web may be provided with printed index bars and registered with an optical reader system.

A preferred system 60 for forming and placing the insert 50 in a cookie as it is formed is shown schematically FIG. 16. As shown therein, web 52 is carried on a roll 61 and fed over an index roller 62 to a cutting station where a cutting knife 63 cuts the web along the cut lines 53. The sheet 51 formed thereby is carried on a folding station, where a folding blade 66 then folds sheet 51 along fold lines 55. The insert 50 formed thereby then is allowed to fall onto a cookie blank 64 carried on a conveyor surface 65. While system 60 is preferred because it may be incorporated relatively easily into conventional automated fortune cookie baking apparatus, other systems may be used and will be obvious to those working in the art.

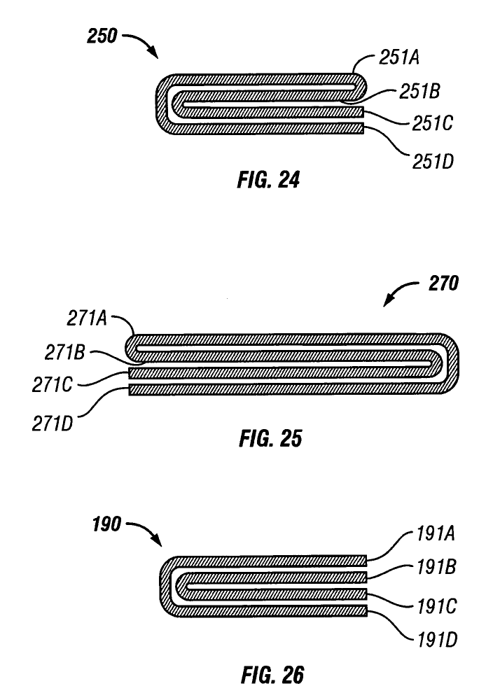

While insert 50 is provided with a single horizontal fold, the novel inserts of the subject invention may comprise two or more horizontal folds. For example, insert 150 shown in FIG. 14 comprises two horizontal folds. The folds are accordion like and form an insert having three layers 151a, 151b, and 151c. Insert 250 shown in FIG. 24 also has two horizontal folds. The insert is formed by folding and then refolding a sheet, and thus, it has four layers 251a, 251b, 251c, and 251d. The precise number of folds and the pattern of folding is a matter of choice, although the limit on the number of folds that may be accommodated in a cookie of a given size will vary depending on the number of factors such as the thickness of the sheet. Generally it may be preferable to use thinner sheets as the number of folds in the insert increases. The apparatus and processes required for folding the substrate also become more complicated as the number of folds and the complexity of the folding pattern is increased. For example, insert 250 may be more easily formed than insert 150 because it may be formed with a single folding blade.

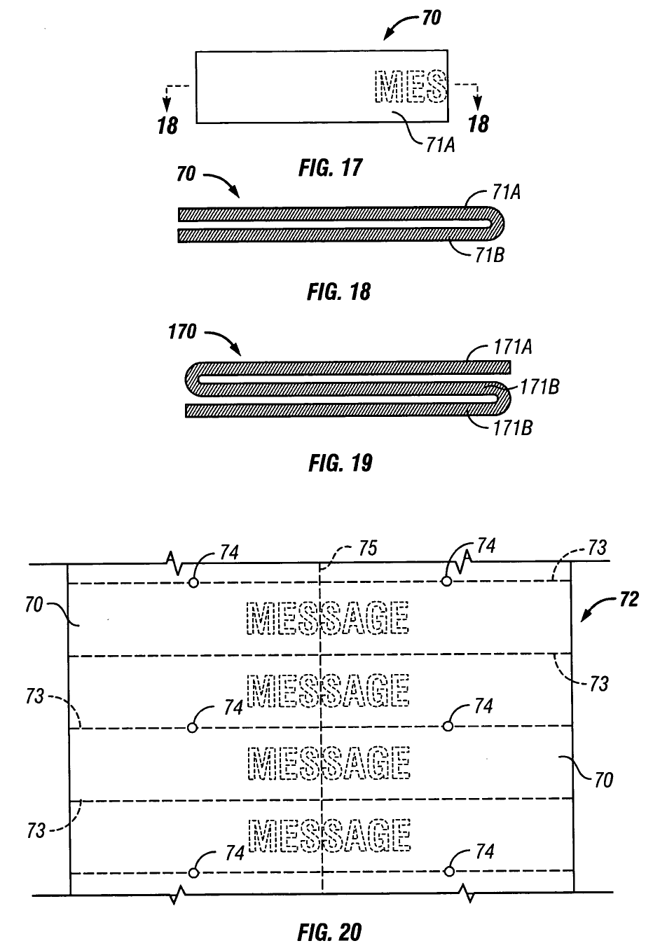

In accordance with a fourth preferred embodiment, the novel advertising inserts comprise an imprintable substrate sheet having a vertical fold therein. For example, as will be appreciated from FIGS. 17 and 18, insert 70 comprises an imprintable substrate sheet 71 having a single fold thereby forming layers 71a and 71b.

The length and width of the formed insert 70, as discussed above in reference to the other preferred embodiments 10, 30, and 50, preferably approximate the length and width of message slips used in traditional fortune cookies, but the dimensions may vary as appropriate. Likewise, the substrate sheet 71 may be composed from the same materials and imprinted as discussed above in reference to the other preferred embodiments.

It will be appreciated that by incorporating a vertical fold, the size of the sheet and the area available for imprinting an advertising message will be increased substantially. For example, if a single vertical fold is used, the sheet may be made twice as large, but the formed insert will still have the height and width of a traditional message insert. Likewise, with two vertical folds the sheet may be made three or four times as large, depending on the folding pattern. The space available for imprinting a message will be likewise increased.

Fortune cookies with the novel advertising insert 70 may be produced by making relatively minor modifications to conventional processes and machinery. For example, as shown in FIG. 20, the novel advertising insert 70 may be fabricated from a continuous web 72 that will provide a plurality of sheets 71 defined by cut lines 73, each having a message imprinted thereon. Preferably, the web 72 is provided with index holes 74 to facilitate feeding and registration of the web 72. Alternately, however, the web may be provided with printed index bars and registered with an optical reader system.

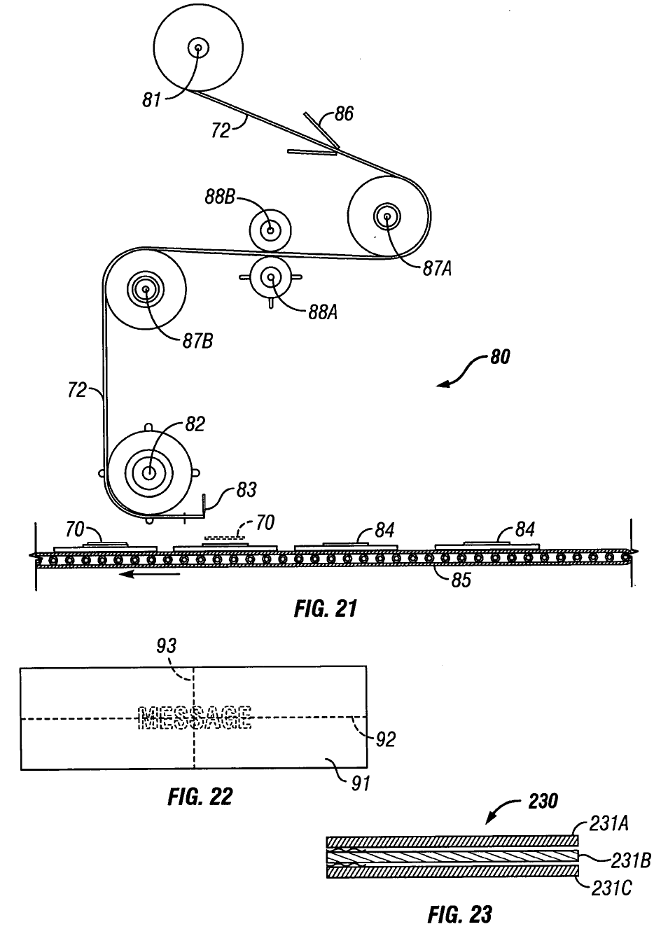

A preferred system 80 for forming and placing the insert 70 in a cookie as it is formed is shown schematically FIG. 21. As shown therein, web 72 is carried on a roll 81 and fed through a plow-type folder 86 which folds web 72 along fold line 75. The folded web 72 is then fed over tension rollers 87a and 87b and through hole punching rollers 88a and 88b which provide web 72 with index holes 74. The web 72 is then fed through an index roller 82 to a cutting station where a cutting knife 83 cuts the folded web 72 along the cut lines 73. The insert 70 formed thereby then is allowed to fall onto a cookie blank 84 carried on a conveyor surface 85. While system 80 is preferred because it may be incorporated relatively easily into conventional automated fortune cookie baking apparatus, other systems may be used and will be obvious to those working in the art.

While insert 70 is provided with a single vertical fold, the novel inserts of the subject invention may comprise two or more vertical folds. For example, insert 170 shown in FIG. 19 comprises two vertical folds. The folds are accordion like and form an insert having three layers 171a, 171b, and 171c. Insert 270 shown in FIG. 25 also has two vertical folds. The insert is formed by folding and then refolding a sheet, and thus, it has four layers 271a, 271b, 271c, and 271d. The precise number of folds and the pattern of folding is a matter of choice, although the limit on the number of folds that may be accommodated in a cookie of a given size will vary depending on the number of factors such as the thickness of the sheet. Generally it may be preferable to use thinner sheets as the number of folds in the insert increases. The apparatus and processes required for folding the substrate also become more complicated as the number of folds and the complexity of the folding pattern is increased. For example, insert 270 may be more easily formed than insert 170 because it may be formed with a single folding blade.

It also will be appreciated that webs 52 and 72 used, respectively, in systems 60 and 80, are vertically oriented. That is, the width of webs 52 and 72 is sized to the desired width of sheets 51 and 71 from which inserts 50 and 70 are formed. For example, the width of web 52 is equal to the desired width for sheet 51 of insert 50. Thus, by horizontally orienting and printing a web, system 60 may be used to apply a vertical fold and system 80 may be used to apply a horizontal fold. For example, if the width of web 52 is sized to the height of sheet 51, system 80 could be used to apply a horizontal fold to web 52 and to ultimately form insert 50.

The novel advertising inserts also may be provided with horizontal and vertical folds. For example, as shown in its unfolded state in FIG. 22, an insert 90 may comprise a sheet 91 having a horizontal fold 92 and a vertical fold 93. Such inserts may be formed, for example, from a system similar to system 80 that also includes a folding blade such as that used in system 60. While folds that are substantially horizontally and vertically oriented are preferred in most cases because they generally maximize the amount of increase in imprintable surface area on a rectangular insert while minimizing the space occupied by the insert, non-vertical and non-horizontal folds and folding patterns may be provided. Moreover, the sheet that is folded to form the insert may have a non-rectangular shape and be provided with folds appropriate to such shape, as will be appreciated by those skilled in the art. Multiple sheet inserts such as inserts 10, 110, 30, 130, 230 may be provided with horizontal or vertical folds or other types of folds. For example, as shown in FIG. 26, insert 190 comprises two sheets having a single horizontal fold, thereby forming an insert having four layers 191a, 191b, 191c, and 191d. Tandem feed systems may be used to provide cookies with more than one novel insert or a novel insert and a traditional fortune message.

It also will be appreciated that instead of a system such as system 80, webs may be prefolded as desired and used in a system such as system 20 to provide folded inserts. For example, inserts 70 may be formed by prefolding and rolling web 72 and then feeding the prefolded web 72 from the roll into system 20. Finally, it will be appreciated that the novel inserts may be completely preformed, and fed into conventional cookie baking apparatus with minor modifications. For example, preformed inserts may be releasably applied to a carrier web and fed via the carrier web to a station where they are flicked or picked off the web and placed on a cookie blank. Alternately, preformed inserts may be stacked, for example, in magazines, and then picked or otherwise dispensed from the magazine onto cookie blanks.

It will be appreciated that by increasing the imprintable area of the insert, more extensive and sophisticated advertising messages may be provided even in traditionally sized fortune cookies. Traditionally sized message slips, assuming the slip includes a traditional “fortune” message, generally have only about 1.72 square inches of imprintable area, and the height of the slip is quite small relative to its width. Such imprintable areas are poorly suited to much more than very simple branding messages, such as an advertisers name, slogan, or logo. In particular, as a practical matter it is impossible to provide a redeemable manufacturer coupon via traditional message slips because of size constraints. A manufacturer typically will include a bar code that is machine readable and used in systems that manage accounting between a coupon issuer and a merchant who honors the coupon. The size of such bar codes must be sufficiently large so that it may be easily and accurately read, but in doing so, there is little or no room left on a traditional message slip to associate an advertising message with the bar code.

In contrast, the novel inserts, by providing significantly greater imprintable areas, may incorporate much more sophisticated advertising messages. Consider, for example, insert 50. Because sheet 51 from which it is formed is at least twice as large as a traditional message slip, a traditional “fortune” message along with a bar code may be imprinted on one face of sheet 51. The other face of sheet 51 then may be used to imprint an advertising message that will inform a consumer of the basic terms of a redeemable manufacturer coupon. At the same time, because the novel inserts comprise relatively thin folded or superimposed sheets, the space required to accommodate the inserts in a fortune cookie is substantially the same.

Preferably the bar code imprinted on the insert meets standards for UPC bar codes utilizing the UCC/EAN-128 Article Numbering System as are known in the industry, but other information may be encoded therein. It also will be appreciated that other machine readable indicia may be provided in association with the coupon or other advertising message, such as suitably encoded magnetic media films, provided they are acceptable for use in association with food products.

Accordingly, when they are used in conjunction with traditionally sized fortune cookies which are made from blanks approximately 3 inches in diameter, the novel inserts preferably will provide an imprintable area in excess of about 3.5 square inches, which is believed to be the approximate maximum total imprintable area provided for in traditionally sized message slips. More preferably, the novel inserts will comprise in excess of about 7.0 square inches, more preferably in excess of about 10.5 square inches, and most preferably in excess of 14.0 square inches so as to provide for more sophisticated advertising messages and, in particular, redeemable manufacturer coupons.

As a further example, inserts 10 and 30 may be used to provide two manufacturer coupons. Two of the sheets incorporated in those inserts may be imprinted with a bar code on one face and an advertising message on the other face. The third sheet could be imprinted with a traditional “fortune” message on one face and a branding message on the other face.

The methods of the subject invention are directed to disseminating advertising messages to consumers of fortune cookies. The novel methods comprise providing an advertising insert for fortune cookies wherein the advertising insert is one of the novel inserts of the subject invention. That is, the inserts are chosen from the group consisting of the novel inserts described herein or any subgroup thereof. A fortune cookie then is produced with the novel insert and distributed to consumer outlets. The fortune cookie with the novel inserts then may be provided to consumers shopping at, purchasing from, targeted by, or otherwise associated with the consumer outlets, thereby disseminating the advertising message to the consumers. The consumer outlet typically will be restaurants or other food service establishments and grocery stores and other retail food outlets.

The subject invention also provides for novel methods for packaging and distributing fortune cookies for dissemination to a target consumer group. Those methods comprise providing fortune cookies having therein an advertising insert which has imprinted thereon an advertising message for a target consumer group. The fortune cookies are packaged in a shipping carton having a machine readable indicator uniquely associated with the advertising message. The indicator then is read and, in response to the reading, the carton containing the fortune cookies is shipped to consumer outlets associated with the target consumer group. The advertising message then may be disseminated to the target consumer group through the consumer outlets.

For example, an advertiser may wish to limit its campaign to consumers in a specific geographical area or associated with specific types of consumer outlets. A code or other indicator may be assigned to that message and stored in a machine readable format or medium which is printed, affixed, or otherwise associated with the shipping carton for cookies containing the advertiser's message. The indicator then may be read so that the cookies will be shipped only to consumer outlets in the geographic area or of the particular type targeted by the advertiser.

The shipping cartons may be any carton suitable for shipping fortune cookies and many such cartons are known and currently in use. Likewise, the machine readable indicator, and the apparatus for reading such indicators, may be selected from any such systems as are known in the art For example, the indicator could be a bar code readable by conventional bar code readers. Alternately, the indicator could be text or numerical code that may be scanned and interpreted by conventional scan readers. The indicator also could be encoded on a microchip, magnetic strip, or other media for recording data. Other systems for storing and reading an indicator are known and may be used if desired.

It will be appreciated, therefore, that the novel methods allow for efficient and effective dissemination of advertising messages to targeted consumers.

While this invention has been disclosed and discussed primarily in terms of specific embodiments thereof, it is not intended to be limited thereto. Other modifications and embodiments will be apparent to the worker in the art.

1. A method for disseminating advertising messages to consumers of fortune cookies, which method comprises:
(a) providing an advertising insert having imprinted thereon an advertising message which may be viewed by a consumer;
(b) producing a fortune cookie with said insert therein;
(c) distributing said fortune cookie with said advertising insert to a consumer outlet; and
(d) distributing said fortune cookie with said advertising insert to consumers associated with said consumer outlets, thereby disseminating said advertising message to said consumers
(e) wherein said insert is selected from the group consisting of
i) inserts comprising a plurality of superimposed, imprintable substrate sheets;
ii) inserts comprising a plurality of imprintable substrate sheets, wherein said substrate sheets are affixed to each other;
iii) inserts comprising an imprintable substrate sheet having a fold therein;
iv) inserts comprising an imprintable substrate having imprinted thereon a manufacturer coupon redeemable by a consumer of said fortune cookie which includes machine readable code associated therewith to facilitate automated processing of said coupon; and
v) inserts having an imprintable surface in excess of 3.5 square inches wherein said fortune cookie is produced from a circular blank approximately 3 inches in diameter.

2. The method of claim 1, wherein said consumer outlet is a food service establishment.

3. A method for packaging and distributing fortune cookies for dissemination to a target consumer group, which method comprises:
(a) providing fortune cookies having therein an advertising insert, said advertising insert having imprinted thereon an advertising message for a target consumer group;
(b) packaging said fortune cookies in a shipping carton having a machine readable indicator uniquely associated with said advertising message;
(c) reading said indicator and in response thereto shipping said carton to consumer outlets associated with said target consumer group, whereby said fortune cookies may be distributed to consumers thereby disseminating said advertising message.

4. The method of claim 1, wherein said insert comprises a plurality of superimposed, imprintable substrate sheets.

5. The method of claim 4, wherein said insert comprises three superimposed imprintable substrate sheets.

6. The method of claim 4, wherein said insert comprises two superimposed imprintable substrate sheets.

7. The method of claim 4, wherein said insert is produced by cutting a plurality of superimposed continuous webs of said imprintable substrate.

8. The method of claim 4, wherein said insert has a fold therein.

9. The method of claim 4, wherein said advertising message imprinted on said insert includes a manufacturer coupon redeemable by a consumer of said fortune cookie which includes machine readable code associated therewith to facilitate automated processing of said coupon.

10. The method of claim 4, said insert comprising a plurality of imprintable substrate sheets, wherein said substrate sheets are affixed to each other.

11. The method of claim 10, wherein said substrate sheets are releasably laminated together.

12. The method of claim 11, wherein said substrate sheets are laminated together with a releasable adhesive.

13. The method of claim 10, wherein said substrate sheets are affixed to each other at only one end of said sheets.

14. The method of claim 10, wherein said substrate sheets are releasably affixed to each other at only one end of said sheets.

15. The method of claim 10, wherein said insert comprises three imprintable substrate sheets.

16. The method of claim 10, wherein said insert comprises two imprintable substrate sheets.

17. The method of claim 10, wherein said laminated insert is produced by cutting a plurality of continuous webs of said imprintable substrate, wherein said substrate webs are affixed to each other together.

18. The method of claim 10, wherein said insert has a fold therein.

19. The method of claim 10, wherein said advertising message imprinted on said insert includes a manufacturer coupon redeemable by a consumer of said fortune cookie which includes machine readable code associated therewith to facilitate automated processing of said coupon.

20. The method of claim 1, wherein said insert comprises an imprintable substrate sheet having a fold therein.

21. The method of claim 20, wherein said insert has a horizontal fold therein.

22. The method of claim 21, wherein said insert has two horizontal folds.

23. The method of claim 21, wherein said insert has a vertical fold therein.

24. The method of claim 21, where said insert is produced by cutting and folding a continuous web of said imprintable substrate.

25. The method of claim 21, wherein said advertising message imprinted on said insert includes a manufacturer coupon redeemable by a consumer of said fortune cookie which includes machine readable code associated therewith to facilitate automated processing of said coupon.

26. The method of claim 20, wherein said insert has a vertical fold therein.

27. The method of claim 26, wherein said insert has two vertical folds.

28. The method of claim 26, where said insert is produced by cutting and folding a continuous web of said imprintable substrate.

29. The method of claim 26, wherein said advertising message imprinted on said insert includes a manufacturer coupon redeemable by a consumer of said fortune cookie which includes machine readable code associated therewith to facilitate automated processing of said coupon.

30. The method of claim 1, wherein said insert comprises an imprintable substrate having imprinted thereon a manufacturer coupon redeemable by a consumer of said fortune cookie which includes machine readable code associated therewith to facilitate automated processing of said coupon.

31. The method of claim 30, wherein said manufacturer coupon includes a bar code associated therewith.

32. The method of claim 30, wherein said manufacturer coupon includes a UPC bar code utilizing the UCC/EAN-128 Article Numbering System.

33. A fortune cookie comprising an advertising insert, wherein said insert is selected from the group consisting of
(a) inserts comprising a plurality of superimposed, imprintable substrate sheets;
(b) inserts comprising a plurality of imprintable substrate sheets, wherein said substrate sheets are affixed to each other;
(c) inserts comprising an imprintable substrate sheet having a fold therein;
(d) inserts comprising an imprintable substrate having imprinted thereon a manufacturer coupon redeemable by a consumer of said fortune cookie which includes machine readable code associated therewith to facilitate automated processing of said coupon; and
(e) inserts having an imprintable surface in excess of 3.5 square inches wherein said fortune cookie is produced from a circular blank approximately 3 inches in diameter.

34. The fortune cookie of claim 33, wherein the insert comprises a plurality of superimposed, imprintable substrate sheets.

35. The fortune cookie of claim 33, wherein the insert comprises a plurality of imprintable substrate sheets, wherein said substrate sheets are affixed to each other.

36. The fortune cookie of claim 33, wherein the insert comprises an imprintable substrate sheet having a horizontal fold therein.

37. The fortune cookie of claim 33, wherein the insert comprises an imprintable substrate sheet having a vertical fold therein.

38. The fortune cookie of claim 33, wherein the insert comprises an imprintable substrate having imprinted thereon a manufacturer coupon redeemable by a consumer of said fortune cookie which includes machine readable code associated therewith to facilitate automated processing of said coupon.

39. The fortune cookie of claim 33, wherein the insert comprises an imprintable surface in excess of 3.5 square inches wherein said fortune cookie is produced from a circular blank approximately 3 inches in diameter.

40. (canceled)

41. (canceled)

42. (canceled)

43. The method of claim 20, wherein said insert comprises an imprintable substrate having imprinted thereon a manufacturer coupon redeemable by a consumer of said fortune cookie which includes machine readable code associated therewith to facilitate automated processing of said coupon.

44. The method of claim 43, wherein said manufacturer coupon includes a bar code associated therewith.

45. The method of claim 43, wherein said manufacturer coupon includes a UPC bar code utilizing the UCC/EAN-128 Article Numbering System.

46. The method of claim 8, wherein said insert has a horizontal fold therein.

47. The method of claim 8, wherein said insert has a vertical fold therein.

48. The method of claim 18, wherein said insert has a horizontal fold therein.

49. The method of claim 18, wherein said insert has a vertical fold therein.
